(19) United States
(12) Patent Application Publication
(10) Pub. No.: US 2024/0303982 A1
(43) Pub. Date: Sep. 12, 2024

(54) IMAGE PROCESSING DEVICE AND IMAGE PROCESSING METHOD

(71) Applicant: Keyence Corporation, Osaka (JP)

(72) Inventors: Kyosuke TAWARA, Osaka (JP); Tsuyoshi YAMAGAMI, Osaka (JP); Yasuhisa IKUSHIMA, Osaka (JP)

(73) Assignee: Keyence Corporation, Osaka (JP)

(21) Appl. No.: 18/443,383

(22) Filed: Feb. 16, 2024

(30) Foreign Application Priority Data
Mar. 7, 2023 (JP) 2023-034683

(51) Int. Cl. G06V 10/94; G06F 3/0484; G06T 7/00; G06T 7/73; G06V 10/764

(52) U.S. Cl. CPC G06V 10/945; G06F 3/0484; G06T 7/0004; G06T 7/73; G06V 10/764; G06T 2200/24; G06T 2207/20081; G06T 2207/20092; G06T 2207/30164

(57) ABSTRACT

The present disclosure is to allow both a rule-based tool and a machine learning tool to be set on a common interface, thereby reducing the time and effort of the user. An image processing device 1: generates a user interface screen for displaying a setting window; receives an input for arranging a machine learning tool and a rule-based tool in the setting window of the user interface screen, and an input of a common data set including a plurality of images to be referred to by the machine learning tool and the rule-based tool; and executes one of the image processing by the machine learning tool or the image processing by the rule-based tool on the data set, and executes the other image processing on the data set after the one image processing is executed.

### CROSS-REFERENCE TO RELATED APPLICATIONS

The present application claims foreign priority based on Japanese Patent Application No. 2023-034683, filed Mar. 7, 2023, the contents of which are incorporated herein by reference.

### BACKGROUND OF THE INVENTION

### Field of the Invention

The present disclosure relates to an image processing device capable of executing image processing by a machine learning tool and image processing by a rule-based tool.

### Description of Related Art

For example, as an inspection device for performing appearance inspection on a workpiece, there has been an inspection device for executing various measurement processes on a target image acquired by an imaging unit, and performing defect detection, the detection of presence or absence of positional deviation, and the like on the workpiece based on a processing result of the measurement process (for example, see JP-A-2015-021760).

According to the inspection device of JP-A-2015-021760, the user can manually construct a processing procedure.

### SUMMARY OF THE INVENTION

In addition to the image processing by a rule-based tool that manually constructs a processing procedure as described in JP-A-2015-021760, image processing software that can use an image processing tool achieved with a machine learning model has also been studied.

The image processing by a rule-based tool processes an image according to a rule set in advance, and thus needs to set only one image, whereas the image processing by a machine learning tool needs to set a plurality of images for training a machine learning model.

Due to the above-described difference in the setting procedure between the rule-based tool and the machine learning tool, no methods for setting a rule-based tool and a machine learning tool on the same interface have been proposed. Therefore, the setting takes time and effort for a user who wants to use both the rule-based tool and the machine learning tool.

The present disclosure has been made in view of the above, and an object of the present disclosure is to allow both a rule-based tool and a machine learning tool to be set on a common interface, thereby reducing the time and effort of the user.

In order to achieve the object above, an image processing device according to the present aspect includes: a UI generation unit configured to generate a user interface screen for displaying a setting window for setting the image processing and to cause a display unit to display the user interface screen; an input unit configured to receive an input for arranging, in the setting window of the user interface screen, a machine learning tool indicating image processing by a machine learning model and a rule-based tool indicating image processing according to a predetermined rule, and an input of a common data set including a plurality of images to be referred to by the machine learning tool and the rule-based tool; and an image processing unit configured to execute one of the image processing by the machine learning tool or the image processing by the rule-based tool on the data set, and execute the other image processing on the data set after the one image processing is executed.

That is, for example, to execute the image processing by the machine learning tool after the positions of the images are corrected by the rule-based tool, a position correction tool, which is an example of the rule-based tool, and the machine learning tool are arranged in the setting window of the user interface screen displayed by the display unit, and the data set is referred to by the position correction tool and the machine learning tool. Thereby, the image processing unit executes the position correction of the images by the rule-based tool on the data set, and then executes the image processing by the machine learning tool on the same data set, which reduces the time and effort for the setting by the user. The image processing by the machine learning tool may include training of a machine learning model. The image processing by the rule-based tool may be executed after the image processing by the machine learning tool.

The UI generation unit may generate a user interface screen for displaying, side by side with the setting window, a data set window for displaying the images included in the data set referred to by both the machine learning tool and the rule-based tool arranged in the setting window. Accordingly, the user can check the images in the data set commonly referred to by the machine learning tool and the rule-based tool on the same user interface screen, which improves the convenience.

The image processing unit may generate a plurality of processed images by executing the image processing by the rule-based tool on the plurality of images constituting the data set. In this case, the UI generation unit may generate a user interface screen for displaying the plurality of processed images in the data set window. Thereby, the user can check whether the image processing by the rule-based tool is correctly executed on the images for training the machine learning model.

The image processing unit may output an inference result of each of the plurality of processed images by executing the image processing by the machine learning tool on the processed images. In this case, the UI generation unit may generate a user interface screen for displaying the plurality of processed images and the inference result corresponding to each of the processed images in the data set window. Thereby, the user can check the inference result based on the images after the rule-based processing that are actually taken as the basis for the inference by the machine learning model.

The image processing unit may: train the machine learning model with the plurality of images displayed in the data set window and a result of executing the image processing by the rule-based tool on the plurality of images; and execute the image processing by the rule-based tool on an inspection target image in which a workpiece is imaged. In this case, the image processing unit may execute the image processing using the trained machine learning model on the inspection target image based on an execution result of the image processing by the rule-based tool. Thereby, the same processing by the rule-based tool as that used for the training can be executed on the inspection target image. Accordingly, the machine learning tool according to the training result can be executed, which improves the accuracy of the machine learning tool.

The image processing unit may: extract a feature from each of the plurality of images included in the data set; detect a position of a workpiece included in the image based on the extracted feature; and execute position correction based on the detected position of the workpiece, such that the workpiece in each of the plurality of images to be subjected to the image processing by the machine learning tool have the same position and posture. In this case, the image processing unit may execute the image processing by the machine learning tool on the plurality of images subjected to the position correction. This improves the efficiency and accuracy of the image processing by the machine learning tool. The position correction may be coordinate conversion on the image itself, or may be a process of correcting the position of the training target area using the machine learning tool. If the image processing unit executes a normalized correlation (pattern) search, the feature may be the luminance value, and if the image processing unit executes geometric search, the feature may be the edge.

The input unit may be configured to receive designation of target areas of the image processing by the machine learning tool in the images included in the data set. In this case, the image processing unit may: execute the position correction such that the position of the workpiece detected in each image is included in the designated target area; and execute the image processing by the machine learning tool on the target area of each image of the data set. Accordingly, the target area of the image processing by the machine learning tool can be narrowed, which improves the efficiency and accuracy of the image processing by the machine learning tool. In addition, if it is desired to perform the image processing on only a part of a workpiece in an image using the machine learning tool, the unnecessary part can be excluded from the determination target by designating the target area in advance. In addition, if only the target area is used for training at the time of training the machine learning model as well, the part other than the target area can be excluded, which improves the training effect.

The UI generation unit may generate a user interface screen for displaying the plurality of images of the data set in the data set window, in a state where the workpiece detected in each image is included in the target area due to the position correction. Accordingly, it is possible to easily check that the area of interest of each image constituting the data set is included in the target area of the image processing by the machine learning tool.

The image processing according to the predetermined rule by the rule-based tool may be pre-processing of emphasizing a feature area in an input image. In this case, the image processing unit may: generate a plurality of pre-processed images emphasizing a feature area of each of the plurality of images constituting the data set by executing the pre-processing on the image; and execute the image processing by the machine learning tool or training of the machine learning model on the plurality of pre-processed images. That is, for example, by executing the processing by the rule-based tool such as contrast adjustment, it is possible to emphasize the part to be determined, thereby lowering the determination difficulty level in the image processing by the machine learning tool executed thereafter.

The UI generation unit may generate a user interface screen for displaying, in the setting window, an indicator indicating that the machine learning tool and the rule-based tool arranged in the setting window both refer to the data set. Accordingly, the user can easily grasp which data set is shared by the machine learning tool and the rule-based tool, which improves the convenience. The indicator may be, for example, a frame indicating one group, or a line or an arrow connecting the tools.

The input unit may: receive user input for causing a first machine learning tool and a first rule-based tool arranged in the setting window to refer to a first data set including a plurality of images and causing a second machine learning tool and a second rule-based tool arranged in the setting window to refer to a second data set including a plurality of images. In this case, the UI generation unit may generate a user interface screen for displaying, in the setting window: a first indicator indicating that the first machine learning tool and the first rule-based tool arranged in the setting window both refer to the first data set; and a second indicator indicating that the second machine learning tool and the second rule-based tool arranged in the setting window both refer to the second data set. That is, in a case of a plurality of data sets, such as a case where a plurality of areas are inspected with respect to a workpiece, a group of tools referring to the data sets corresponding to the respective areas can be displayed on the user interface screen while being distinguished, which improves the convenience. The present invention may include an aspect in which a third machine learning tool and a third rule-based tool both refer to a third data set. In this case, a third indicator indicating that the third machine learning tool and the third rule-based tool both refer to the third data set may be displayed in the setting window.

As described above, it is possible to allow both a rule-based tool and a machine learning tool to be set on a common interface, thereby reducing the time and effort of the user.

### BRIEF DESCRIPTION OF THE DRAWINGS

FIG. 1 is a schematic diagram illustrating the configuration of an image processing device according to an embodiment of the present invention;

FIG. 2 is a block diagram illustrating the hardware configuration of the image processing device;

FIG. 3 is a diagram illustrating an example in which a workpiece image is processed by a machine learning model;

FIG. 4 is a flowchart illustrating an example of a procedure of an inspection setting of the image processing device;

FIG. 5 is a diagram illustrating an example of a setting user interface screen;

FIG. 6 is a diagram corresponding to FIG. 5 in which an imaging tool is added;

FIG. 7 is a diagram corresponding to FIG. 5 in which an AI tool is added;

FIG. 8 is a diagram corresponding to FIG. 5 in which other tools are added;

FIG. 9 is a diagram corresponding to FIG. 5 in which a data set is received;

FIG. 10 is a flowchart illustrating an example of a process in operation of the image processing device;

FIG. 11 is a diagram illustrating a setting user interface screen when a rule-based tool is executed after the AI tool is executed;

FIG. 12 is a flowchart illustrating a process when the rule-based tool is executed after the AI tool is executed;

FIG. 13 is a diagram illustrating a setting user interface screen when a plurality of AI tools are combined;

FIG. 14 is a diagram illustrating a setting user interface screen displayed when setting the target area of the image processing;

FIG. 15 is a diagram corresponding to FIG. 14 after the position correction;

FIG. 16 is a diagram illustrating a setting user interface screen at the time of AI tool selection;

FIG. 17 is a diagram illustrating a setting user interface screen when a plurality of imaging units are provided;

FIG. 18 is a diagram illustrating an example of an imaging setting window;

FIG. 19 is a diagram illustrating an example of a multiple imaging setting window; and

FIG. 20 is a diagram illustrating another example of an indicator.

### DETAILED DESCRIPTION

Hereinafter, an embodiment of the present invention will be described in detail with reference to the drawings. The following description of a preferred embodiment is essentially nothing more than an illustration, and is not to limit the present invention, an application thereof, or a usage thereof.

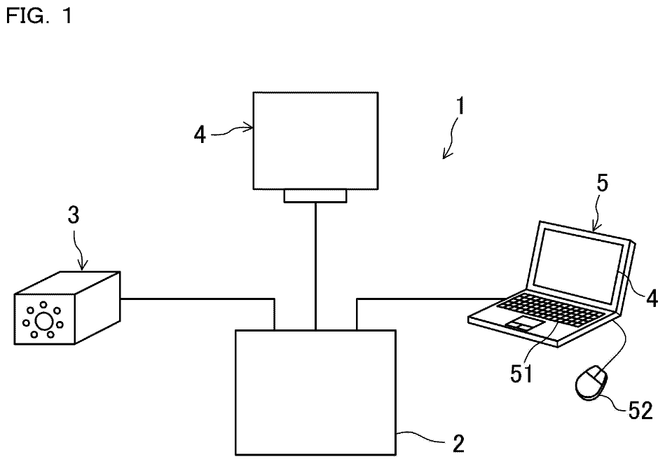

FIG. 1 is a schematic diagram illustrating the configuration of an image processing device 1 according to an embodiment of the present invention. The image processing device 1 is a device for determining the quality of a workpiece image obtained by imaging a workpiece as the inspection target, such as various parts or products, and can be used in a production site such as a factory. Specifically, a machine learning model is constructed inside the image processing device 1, and the machine learning model is generated by training with a plurality of training images.

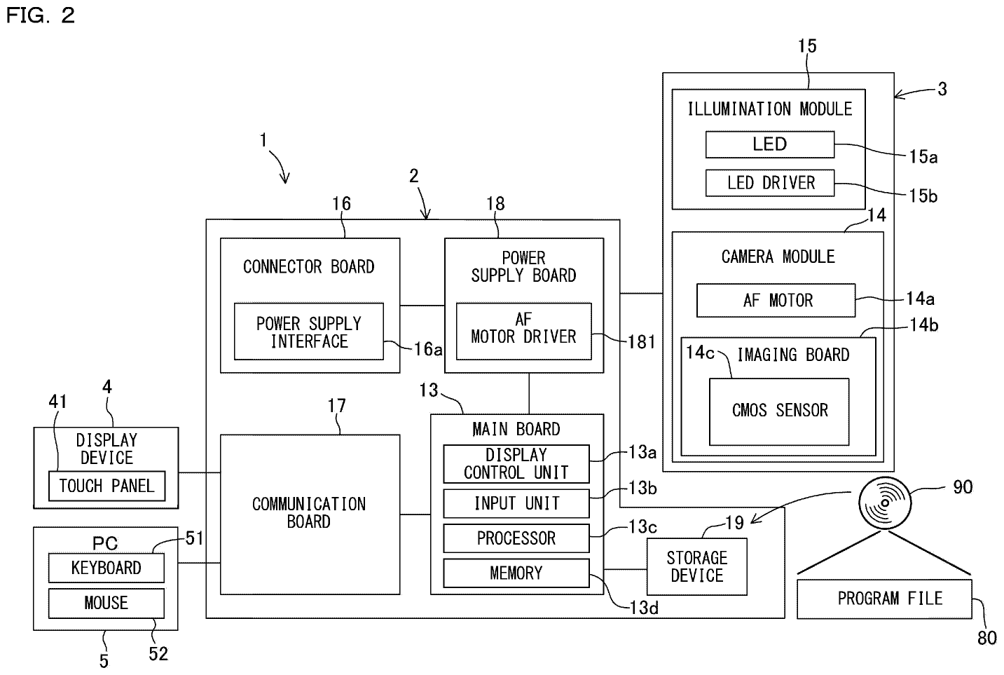

As illustrated in FIG. 2, the image processing device 1 includes a control unit 2 serving as a device body, an imaging unit 3, a display device (display unit) 4, and a personal computer 5. The personal computer 5 is not essential and may be omitted. The personal computer 5 can be used instead of the display device 4 to display various information and images, and the functions of the personal computer 5 can be incorporated into the control unit 2 or into the display device 4.

In FIG. 1, the control unit 2, the imaging unit 3, the display device 4, and the personal computer 5 are illustrated as an example of a configuration example of the image processing device 1, but any ones among them can be combined and integrated. For example, the control unit 2 and the imaging unit 3 may be integrated, or the control unit 2 and the display device 4 may be integrated. Further, the control unit 2 may be divided into a plurality of units and some may be incorporated into the imaging unit 3 or the display device 4, or the imaging unit 3 may be divided into a plurality of units and some may be incorporated into another unit. The image processing device 1 can be used to execute all the steps of the image processing method according to the present invention.

### Configuration of Imaging Unit 3

As illustrated in FIG. 2, the imaging unit 3 includes a camera module (imaging section) 14 and an illumination module (illumination section) 15, and is a unit for acquiring a workpiece image. The camera module 14 includes an AF motor 14a for driving an imaging optical system and an imaging board 14b. The AF motor 14a is a part for automatically performing the focus adjustment by driving the lenses of the imaging optical system, and can perform the focus adjustment by a method known in the related art such as contrast autofocus. The imaging board 14b includes a CMOS sensor 14c as a light detection element for detecting light incident from the imaging optical system. The CMOS sensor 14c is an imaging sensor configured to acquire a color image. Instead of the CMOS sensor 14c, a light detection element such as a CCD sensor may be used.

The illumination module 15 includes a light emitting diode (LED) 15a as a light emitting body for illuminating the imaging area including the workpiece, and an LED driver 15b for controlling the LED 15a. The light emission time point, light emission period, and light emission amount of the LED 15a can be controlled freely by the LED driver 15b. The LED 15a may be provided integrally with the imaging unit 3 or may be provided as an external illumination unit separate from the imaging unit 3.

### Configuration of Display Device 4

The display device 4 includes a display panel such as a liquid crystal panel or an organic EL panel, and is controlled by a processor 13c or a display control unit 13a of the control unit 2 described later. The workpiece image and the various user interface screens output from the control unit 2 are displayed by the display device 4. If the personal computer 5 has a display panel, the display panel of the personal computer 5 can be used instead of the display device 4.

### Operation Device

Examples of the operation device for the user to operate the image processing device 1 include a keyboard 51 and a mouse 52 of the personal computer 5, but are not limited thereto, and may be any device that can receive various operations by the user. For example, a pointing device such as a touch panel 41 of the display device 4 is also included in the operation device.

The operation on the keyboard 51 or the mouse 52 by the user can be detected by the control unit 2. The touch panel 41 is, for example, a touch operation panel known in the related art that is equipped with a pressure-sensitive sensor, and a touch operation by the user can be detected by the control unit 2. The same applies to the case of using other pointing devices.

### Configuration of Control Unit 2

The control unit 2 includes a main board 13, a connector board 16, a communication board 17, and a power supply board 18. The main board 13 is provided with a display control unit (UI generation unit) 13a, an input unit 13b, and a processor (image processing unit) 13c. The display control unit 13a generates a user interface screen or the like for displaying a setting window for setting the image processing executed by the image processing device 1, which will be described in detail later. The various user interface screens generated by the display control unit 13a are displayed by the display device 4.

The display control unit 13a and the input unit 13b can be configured with, for example, an arithmetic device mounted on the main board 13. The display control unit 13a, the input unit 13b, and the processor 13c may be configured with a single arithmetic device, or the display control unit 13a, the input unit 13b, and the processor 13c may be configured with separate arithmetic devices.

The display control unit 13a, the input unit 13b, and the processor 13c control the operations on the connected boards and modules. For example, the processor 13c outputs an illumination control signal for controlling on/off of the LED 15a to the LED driver 15b of the illumination module 15. The LED driver 15b switches on/off and adjusts the lighting time of the LED 15a in response to the illumination control signal from the processor 13c, and adjusts the amount of light of the LED 15a and the like.

The processor 13c outputs an imaging control signal for controlling the CMOS sensor 14c to the imaging board 14b of the camera module 14. The CMOS sensor 14c starts imaging in response to the imaging control signal from the processor 13c, and adjusts the exposure time to any time to perform imaging. That is, the imaging unit 3 images the inside of the visual field range of the CMOS sensor 14c in response to the imaging control signal output from the processor 13c. If a workpiece is within the visual field range, the imaging unit 3 images the workpiece, but if an object other than the workpiece is within the visual field range, the imaging unit 3 can also image the object. For example, the image processing device 1 can capture a non-defective product image corresponding to a non-defective product and a defective product image corresponding to a defective product by the imaging unit 3 as training images for the machine learning model. A training image may not be an image captured by the imaging unit 3, and may be an image captured by another camera or the like.

On the other hand, in operation of the image processing device 1, a workpiece can be imaged by the imaging unit 3. The CMOS sensor 14c is configured to output a live image, that is, a currently captured image at a short frame rate as needed.

When the imaging by the CMOS sensor 14c is completed, the image signal output from the imaging unit 3 is input to and processed by the processor 13c of the main board 13, and is stored in a memory 13d of the main board 13. The details of the specific processing contents by the processor 13c of the main board 13 will be described later. The main board 13 may be provided with a processing device such as an FPGA or a DSP. Alternatively, the processor 13c may be obtained by integrating processing devices such as an FPGA and a DSP.

The connector board 16 is a portion that receives power from the outside via a power supply connector (not illustrated) provided in a power supply interface 16a. The power supply board 18 is a portion for distributing the power received by the connector board 16 to each board, module, and the like, and specifically distributes the power to the illumination module 15, the camera module 14, the main board 13, and the communication board 17. The power supply board 18 includes an AF motor driver 181. The AF motor driver 181 supplies driving power to the AF motor 14a of the camera module 14 to achieve autofocus. The AF motor driver 181 adjusts the power supplied to the AF motor 14a in response to the AF control signal from the processor 13c of the main board 13.

The communication board 17 is a part for executing the communication between the main board 13 and the display device 4 and the personal computer 5, the communication between the main board 13 and an external control device (not illustrated), and the like. Examples of the external control device include a programmable logic controller. The communication may be wired or wireless, and either communication mode can be achieved by a communication module known in the related art.

The control unit 2 is provided with a storage device (storage unit) 19 including, for example, a solid state drive or a hard disk drive. The storage device 19 stores a program file 80, a setting file, and the like (software) for enabling the controls and processes described later to be executed by the above-described hardware. The program file 80 and the setting file are stored in a storage medium 90 such as an optical disk, and the program file 80 and the setting file stored in the storage medium 90 can be installed in the control unit 2. The program file 80 may be downloaded from an external server using a communication line. The storage device 19 may store, for example, the above-described image data, the parameters for constructing a machine learning model of the image processing device 1, and the like.

### Types of Image Processing

The image processing device 1 is configured to execute both the image processing according to a predetermined rule and the image processing using a machine learning model. The image processing according to a predetermined rule can be called rule-based image processing. In the rule-based image processing, the user manually constructs the processing procedure. A tool indicating image processing according to a predetermined rule is referred to as a rule-based tool. The rule-based tool includes, for example, a pre-processing tool for performing contrast adjustment on a workpiece image, a position correction tool for correcting the position and the posture of a workpiece, a dimension geometric tool for extracting the dimensions and the geometric shape of a workpiece, and a defect tool for extracting a defect on the outer surface of a workpiece. The defect tool is an example of a normal inspection tool indicating the image inspection based on a predetermined rule.

On the other hand, the image processing by the machine learning model can be referred to as AI-type image processing which enables the image processing by training the machine learning model with images and labeled training data. In the image processing by the machine learning model, first, a plurality of images (training images) and labeled training data are input to the machine learning model for training, thereby generating a trained machine learning model. An input image is input to the trained machine learning model, and the machine learning model is caused to execute image processing such as classification, determination, detection, and location. In the present embodiment, the training by the machine learning model is included in the image processing. A tool indicating the image processing using the machine learning model is referred to as a machine learning tool (AI tool). The machine learning tool includes a classification tool indicating the classification of classifying an input image into any of a plurality of classes by the machine learning model, a determination tool indicating determination of determining the quality of the input image by the machine learning model, a detection tool indicating detection of detecting an object or a defect included in the input image by the machine learning model, a location tool indicating location of locating an object included in the input image by the machine learning model, and the like.

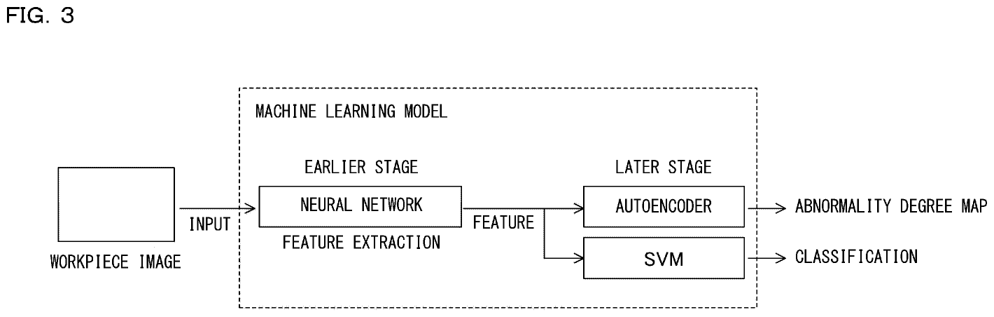

The processor 13c can construct the machine learning model by the processor 13c reading the parameters stored in the storage device 19. As illustrated in FIG. 3, the machine learning model includes a neural network, an autoencoder, a support vector machine (SVM), and the like. The processor 13c inputs a workpiece image obtained by imaging a workpiece as the inspection target to the neural network constructed as described above. This is the earlier stage. When the workpiece image is input to the neural network, the neural network performs feature extraction, and the extracted features are input to an autoencoder and/or a support vector machine for executing the later stage. The neural network for performing the feature extraction in the earlier stage may be a convolutional neural network trained in advance, or may be a convolutional neural network configured to be additionally trained using the automatic training described later. In the machine learning model illustrated in FIG. 3, a plurality of features having different scales (feature map) may be extracted from a plurality of layers of the convolutional neural network, and the plurality of features may be input to the autoencoder and/or the support vector machine.

The autoencoder generates and outputs an abnormality degree map (heat map) based on the input features. The processor 13c executes determination of determining whether the workpiece image belongs to a first class or a second class based on the abnormality degree map output from the autoencoder. For example, the first class may be a non-defective class, and the image belonging to the first class may be a non-defective product image obtained by imaging a non-defective product. The second class may be a defective class, and the image belonging to the second class may be a defective product image obtained by imaging a defective product.

On the other hand, the support vector machine executes classification of classifying the workpiece image into a plurality of classes based on the input features. The plurality of classes include the first class and the second class, so that the processor 13c can classify the workpiece image into the non-defective class and the defective class. The plurality of classes may include a third class, a fourth class, and the like, and the number of classes is not particularly limited.

The machine learning model according to the present embodiment is not limited to autoencoder or SVM, and other machine learning models may be used.

The processor 13c of the image processing device 1 can determine whether the workpiece is a non-defective product or a defective product by executing the above-described determination and classification. The image processing device 1 having such a function can inspect the appearance of the workpiece, and thus can be referred to as an appearance inspection device or the like. The workpiece as the inspection target of the image processing device 1 may be the inspection target entirely, or a part of the workpiece may be the inspection target alone. One workpiece may include a plurality of inspection targets. The workpiece image may include a plurality of workpieces.

### Inspection Setting of Image Processing Device 1

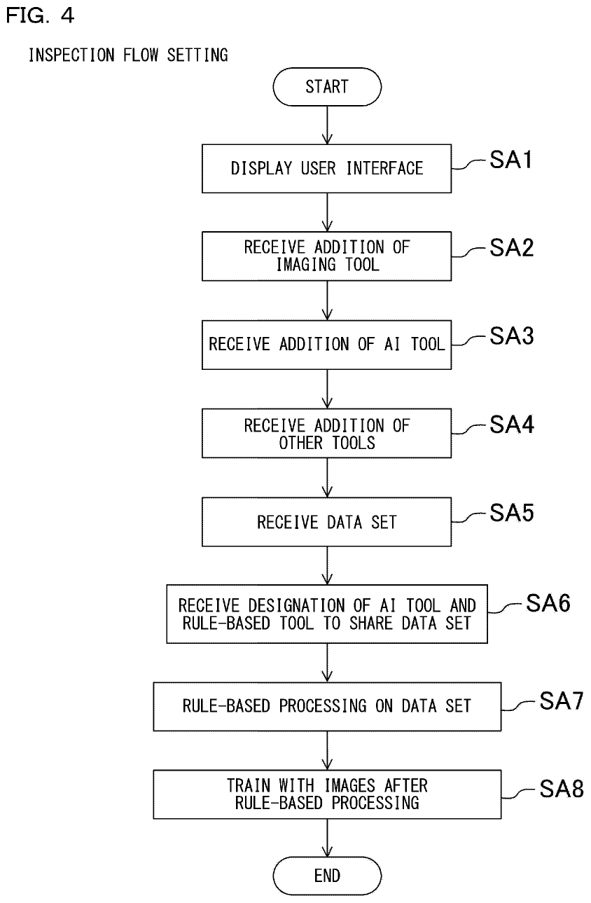

Next, the inspection setting of the image processing device 1 will be described. The inspection setting refers to the setting of the image processing. FIG. 4 is a flowchart illustrating an example of the procedure of the inspection setting of the image processing device 1, and is executed when the user performs a start operation of the inspection setting. The start operation of the inspection setting is, for example, an operation on a start button. The flowchart of FIG. 4 starts when the input unit 13b detects that the input unit 13b is operated by the mouse 52 or the like.

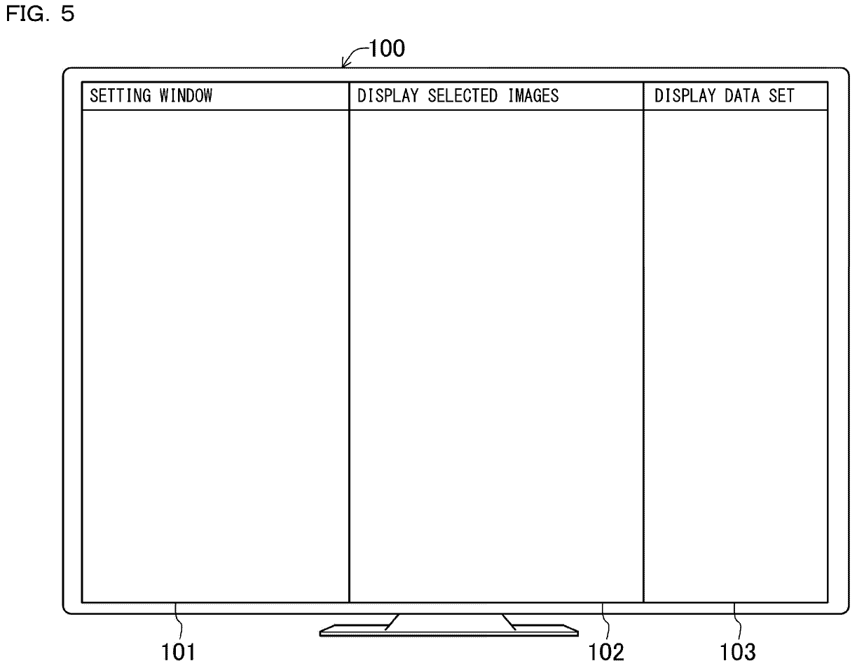

In step SA1, the display control unit 13a generates a setting user interface screen 100 illustrated in FIG. 5 and causes the display device 4 to display the image display user interface screen 100. The setting user interface screen 100 includes a setting window 101, a selected image display area 102, and a data set window 103. The setting window 101 is a window for setting the image processing. The data set window 103 is an area for displaying the list of a data set including a plurality of images in a thumbnail format. The selected image display area 102 is an area for enlarging and displaying the image selected from the plurality of images displayed in the data set window 103.

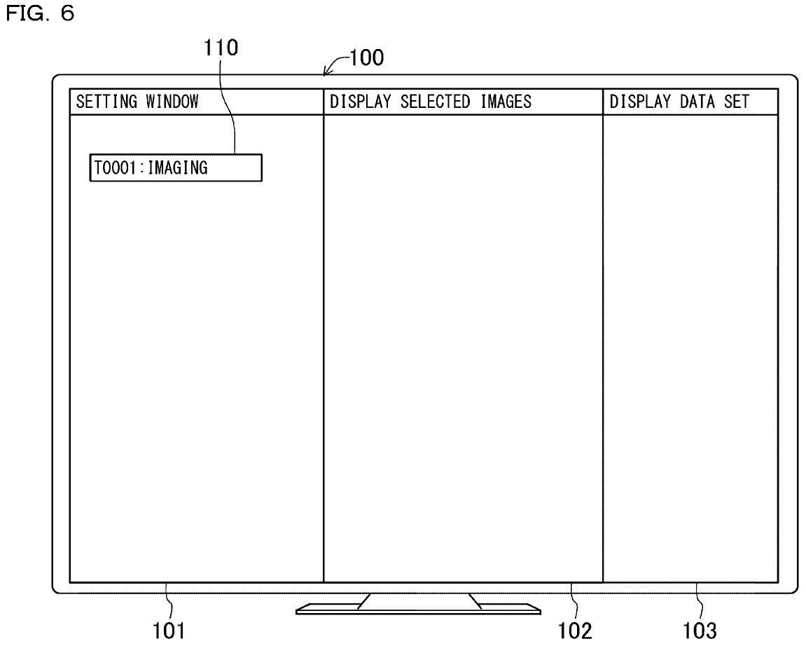

In step SA2, the addition of an imaging tool 110 is received as illustrated in FIG. 6. When the user selects the imaging tool 110 with the mouse 52 or the like, the input unit 13b receives the selection operation of the imaging tool 110 as the user input. When the input unit 13b receives the selection operation of the imaging tool 110, the processor 13c specifies that the imaging tool 110 is selected and arranges the imaging tool 110 at the beginning of the main routine. Then, as illustrated in FIG. 6, the display control unit 13a generates the setting user interface screen 100 in which the imaging tool 110 is arranged at the top of the main routine of the setting window 101, and causes the display device 4 to display the setting user interface screen 100.

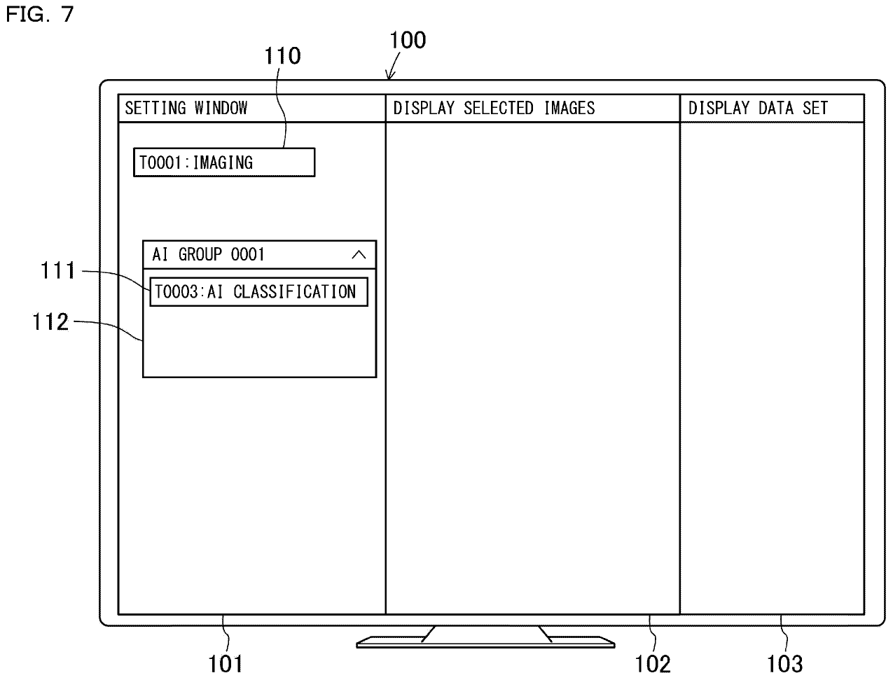

In step SA3 of the flowchart illustrated in FIG. 4, the addition of an AI classification tool 111 is received as illustrated in FIG. 7. The present embodiment will describe a case where the addition of the AI classification tool 111 as an AI tool is received, but the same applies to a case where the addition of the other AI tools is received. That is, the AI classification tool 111 is a tool capable of inputting training images to a machine learning model to train the machine learning model, and executing the classification after the training. When the user selects the AI classification tool 111 with the mouse 52 or the like, the input unit 13b receives the selection operation of the AI classification tool 111 as the user input. When the input unit 13b receives the selection operation of the AI classification tool 111, the processor 13c specifies that the AI classification tool 111 is selected and arranges the AI classification tool 111 below the imaging tool 110 in the main routine. Then, as illustrated in FIG. 7, the display control unit 13a generates the setting user interface screen 100 arranged below the imaging tool 110 in the main routine set in the setting window 101 by the AI classification tool 111, and causes the display device 4 to display the setting user interface screen 100.

In addition to the generation of the AI classification tool 111, the display control unit 13a generates a frame 112 surrounding the AI classification tool 111 and displays the frame 112 in the setting window 101. The frame 112 is an example of an indicator indicating that the machine learning tool and the rule-based tool arranged in the setting window 101 both refer to a common data set.

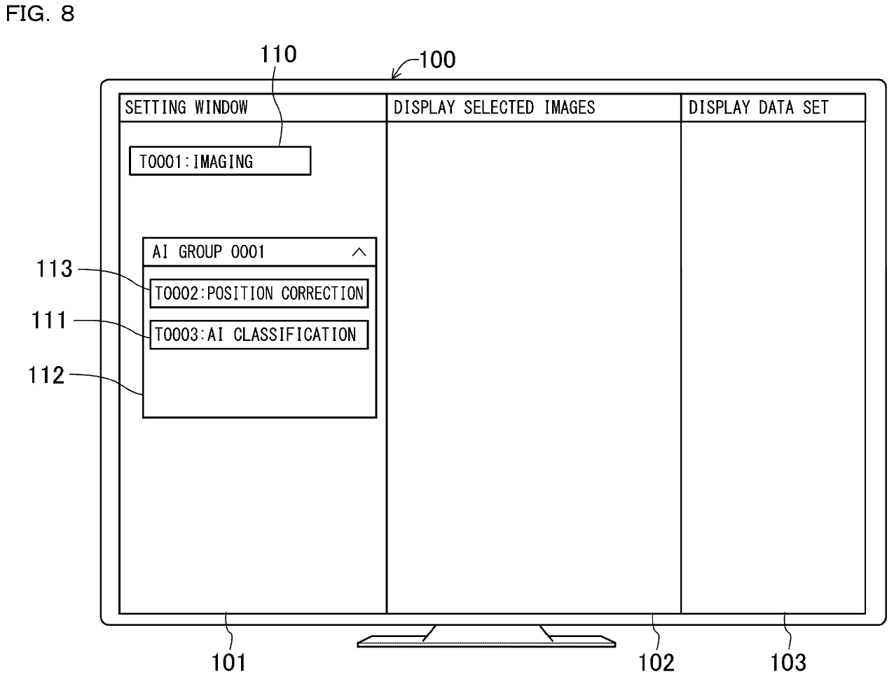

In step SA4, as illustrated in FIG. 8, the addition of other tools is received. Specifically, when the user detects an operation of inserting others tools into the frame 112, the input unit 13b receives the operation as an addition operation of other tools. The processor 13c specifies the added tools.

The other tools to be added in the frame 112 may be a machine learning tool or a rule-based tool. In the present embodiment, a position correction tool for correcting the position and posture of the workpiece included in the image is added in Step SA4. The position correction tool is an example of a rule-based tool. The tool added to the frame 112 is not limited to the above-described position correction tool, and may be, for example, a tool for measuring dimensions, a tool for extracting edges, or the like. The number of tools to be added in the frame 112 is not particularly limited. A plurality of tools arranged in each frame 112 forms one group.

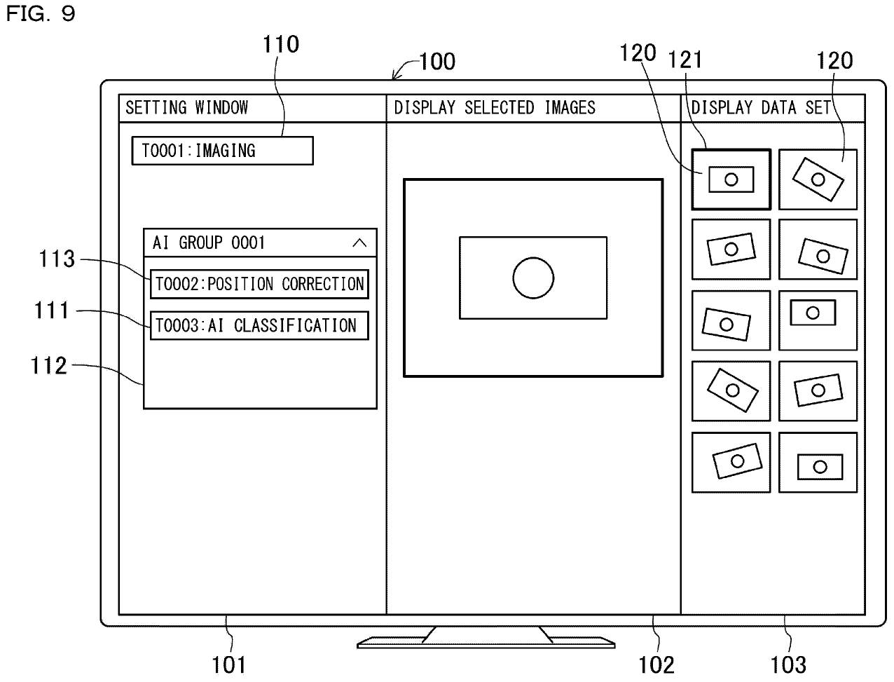

In step SA5, as illustrated in FIG. 9, a data set including a plurality of images is received. The data set may include a plurality of workpiece images captured by the imaging tool 110, or may include a plurality of images stored in the storage device 19, for example. If the data set includes a plurality of stored images, the storage destination may be designated by operating the mouse 52 or the like, and a plurality of images may be read from the storage destination.

The input unit 13b receives a designation operation of a data set as the user input. When the input unit 13b receives the designation operation of the data set, the processor 13c specifies that the data set is designated. Then, as illustrated in FIG. 9, the display control unit 13a generates the setting user interface screen 100 for displaying a plurality of images 120 constituting the data set in a thumbnail format in the data set window 103, and causes the display device 4 to display the setting user interface screen 100. When the user selects any one of the plurality of images 120 displayed in the data set window 103, the display control unit 13a generates and displays a selected mark 121 in a manner surrounding the selected image 120. The selection operation on any image 120 can be performed by, for example, the mouse 52, and the processor 13c specifies the one image 120 selected by the user. When the processor 13c specifies the image 120 selected by the user, the display control unit 13a displays the image 120 in the selected image display area 102 in an enlarged manner. Steps SA2, SA3, SA4, and SA5 do not have a particular order, and may be executed from any step.

In step SA6, the designation of the AI tool and the rule-based tool for sharing the data set is received. The designation in this step can be received by referring to the result of step SA4. That is, the tools added in the frame 112 surrounding the AI classification tool 111 are set as tools referring to the common data set. The operation of adding tools into the frame 112 surrounding the AI classification tool 111 is a user input for causing the machine learning tool and the rule-based tool arranged in the setting window 101 to refer to the common data set. The user input is received by the input unit 13b. That is, the display control unit 13a generates the user interface screen 100 for displaying, side by side with the setting window 101, the data set window 103 for displaying the images included in the data set referred to by both the machine learning tool and the rule-based tool arranged in the setting window 101, and causes the display device 4 to display the generated user interface screen 100. Therefore, the user can check the images in the data set commonly referred to by the machine learning tool and the rule-based tool on the same user interface screen 100, which improves the convenience.

In step SA7, the image processing by the rule-based tool is executed on the data set. In step SA8, the image processing by the AI tool is executed on the data set after the image processing by the rule-based tool is executed. That is, the processor 13c executes the position correction of the images by the rule-based tool on the data set, and then executes the image processing by the machine learning tool on the same data set, which reduces the time and effort for setting by the user.

In this example, as illustrated in FIG. 9, the rule-based tool is a position correction tool 113, the AI tool is the AI classification tool 111, and the position correction tool 113 is arranged above the AI classification tool 111. Therefore, the position correction is executed on the data set in step SA7 before the image processing by the AI classification tool 111. Specifically describing the position correction tool 113, when the image processing by the position correction tool 113 is to be executed, the processor 13c first extracts the feature from each of the plurality of images included in the data set. After extracting the feature from each of the plurality of images, the processor 13c detects the position of the workpiece included in each image based on the extracted feature. The processor 13c executes the position correction based on the detected position of the workpiece, such that the workpiece in each of the images to be subjected to the image processing by the AI classification tool 111 have the same position and posture. If the processor 13c executes a normalized correlation (pattern) search, the feature may be the luminance value, and if the processor 13c executes geometric search, the feature may be the edge.

After the position correction is executed, in step SA8, the data set after the position correction is input to the machine learning model, and the training of the machine learning model is executed. Thus, a machine learning model capable of classification is generated. In addition to the classification, a similar procedure can be used to generate a machine learning model capable of determination, detection, location, or the like.

### Operation of Image Processing Device 1

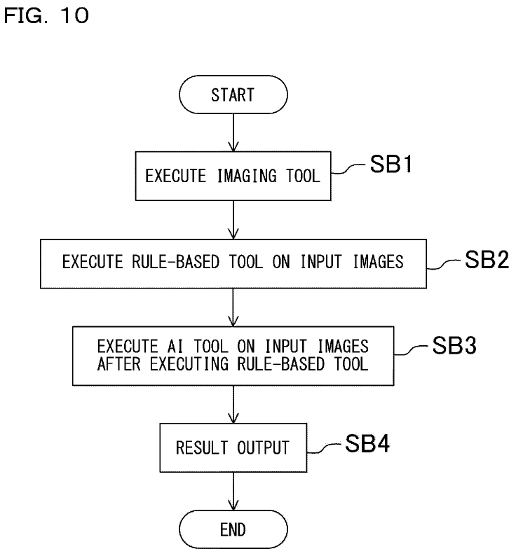

Next, the operation of the image processing device 1 will be described. FIG. 10 is a flowchart illustrating an example of the process in operation of the image processing device 1. The process is started after the user issues an operation start instruction after the above-described setting is completed. In step SB1 after the start, the processor 13c executes the imaging tool 110 at a predetermined time point. The predetermined time point is, for example, a time point at which an imaging trigger signal is input from an external device, a time point at which an imaging trigger signal is generated in the image processing device 1, or the like. If the image processing device 1 is operated in a field where a plurality of workpieces are sequentially conveyed on a conveyance line, the time point at which the workpiece reaches a predetermined position may be the above-described predetermined time point. When the imaging tool 110 is executed at a predetermined time point, the imaging unit 3 images the workpiece. Thus, a workpiece image is acquired as the input image. When the imaging unit 3 executes multiple imaging, a plurality of input images are acquired.

In step SB2, the image processing by the rule-based tool is executed on the input images acquired in step SB1. In Step SB3, the image processing by the AI tool is executed on the input images after the image processing by the rule-based tool is executed. In this example, as illustrated in FIG. 9, since the rule-based tool is the position correction tool 113 and the AI tool is the AI classification tool 111, the position correction is executed on the input image in step SB2, and then the input image after the position correction is input to the machine learning model and classified in step SB3. Thereafter, in step SB4, a classification result by the machine learning model is output. The classification result is, for example, displayed by the display device 4 or the like and stored in the storage device 19.

As described above, the processor 13c generates a trained machine learning model by training the machine learning model with a plurality of images displayed in the data set window 103 of the setting user interface screen 100 and a result of executing the image processing by the rule-based tool on the plurality of images. Then, the processor 13c can execute the image processing by the rule-based tool on the input image as the inspection target image in which the workpiece is imaged, and then execute the image processing using the trained machine learning model on the input image based on the execution result of the image processing by the rule-based tool.

In the example described above, the image processing by the AI tool is executed on the input image on which the position correction has been executed, but the present invention is not limited thereto. The position correction result acquired by executing the position correction (position correction data) may be acquired from the position correction tool 113, the acquired position correction result may be delivered to the AI tool, and the image processing by the AI tool may be executed based on the delivered position correction result.

### Order for Executing AI Tool and Rule-Based Tool

In the above-described example, the image processing by the AI tool is executed after the image processing by the rule-based tool is executed, but this order may be reversed. That is, the image processing by the rule-based tool may be executed after the image processing by the AI tool is executed.

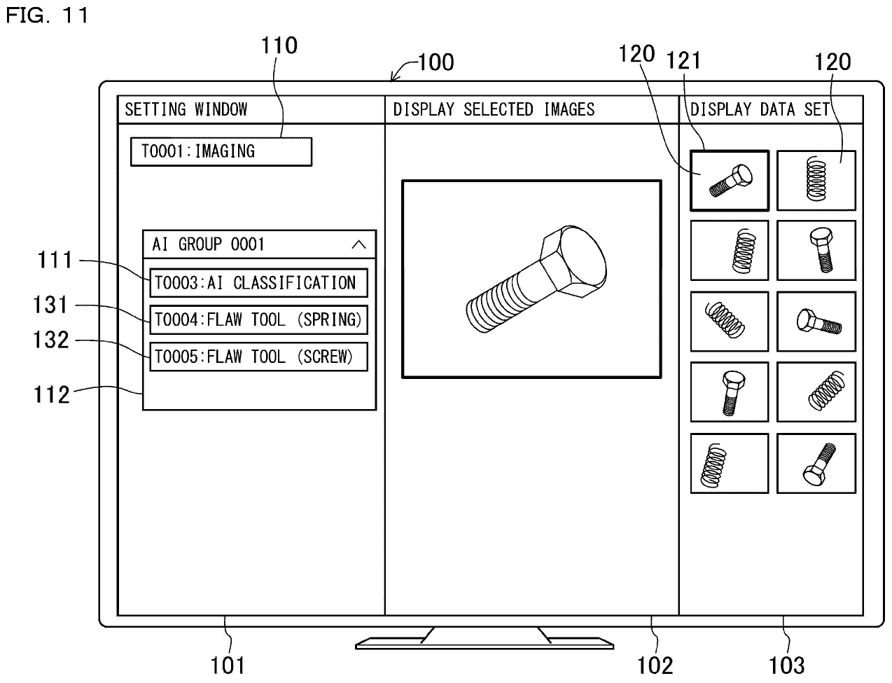

Hereinafter, an example in which the image processing by the rule-based tool is executed after the image processing by the AI tool is executed based on the setting user interface screen 100 illustrated in FIG. 11 will be described. In this example, the workpieces include springs and screws, and workpiece images obtained by imaging the springs and workpiece image obtained by imaging the screws are input to the image processing device 1 as input images in operation. The AI classification tool 111 is added as an AI tool. The AI classification tool 111 is configured with a machine learning model for classifying an input image into a spring image obtained by imaging a spring or a screw image obtained by imaging a screw.

In the frame 112 surrounding the AI classification tool 111, a flaw tool (spring) 131 and a flaw tool (screw) 132 are added as normal inspection tools. The flaw tool (spring) 131 and the flaw tool (screw) 132 are arranged below the AI classification tool 111. That is, since the workpieces include both springs and screws, the user adds “T0004: flaw tool (spring)” as a spring flaw detection tool for detecting a flaw in a spring in an image classified as a spring image by the AI classification tool 111 and “T0005: flaw tool (screw)” as a screw flaw detection tool for detecting a flaw in a screw in an image classified as a screw image by the AI classification tool 111. Alternatively, a spring dimension tool for measuring the dimensions of the spring or a screw dimension tool for measuring the dimensions of the screw may be added. These dimension tools are also rule-based tools. For example, a dimension tool for measuring the outer diameter may be used in the case of a spring, and a tool for measuring the total length may be used in the case of a screw.

The flaw tool (spring) 131 is a normal inspection tool corresponding to one class classified by the AI classification tool 111. The flaw tool (screw) 132 is a normal inspection tool corresponding to the other class classified by the AI classification tool 111. In this way, the input unit 13b can receive a user input for: arranging in the setting window 101 the AI classification tool 111 and the normal inspection tools 131 and 132 corresponding to the respective classes of the plurality of classes classified by the AI classification tool 111; and causing the AI classification tool 111 and the plurality of normal inspection tools 131 and 132 arranged in the setting window 101 to refer to the common data set including the plurality of images.

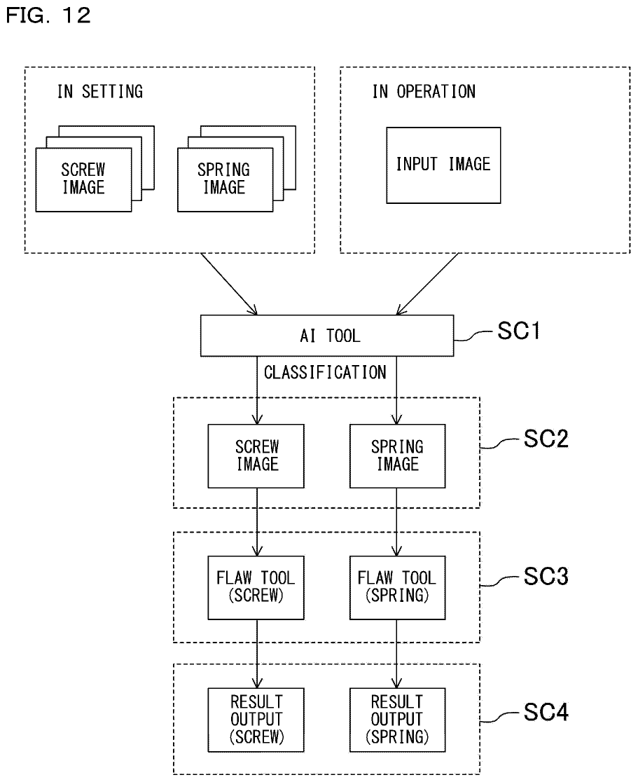

As illustrated in the flowchart of FIG. 12, to perform the inspection setting, a plurality of screw images and a plurality of spring images are prepared in advance. The plurality of images constitute a data set. As illustrated in FIG. 11, since the AI classification tool 111, the flaw tool (spring) 131, and the flaw tool (screw) 132 are included in the frame 112, the data set is shared by the AI classification tool 111, the flaw tool (spring) 131, and the flaw tool (screw) 132.

In step SC1 at the time of setting, the data set is input to the machine learning model to train the machine learning model. Thus, a machine learning model capable of classifying spring images and screw images is generated.

In operation, an input image acquired by executing the imaging tool is input to the AI classification tool 111 in step SC1. As a result of the image processing by the AI classification tool 111, as illustrated in step SC2, if the input image is a screw image, the input image is classified as a screw image, and if the input image is a spring image, the input image is classified as a spring image.

Thereafter, in step SC3, the image processing by the flaw tool (screw) 132 is executed on an image classified as a screw image by the AI classification tool 111, and image processing by the flaw tool (spring) 131 is executed on an image classified as a spring image by the AI classification tool 111. As described above, the processor 13c classifies each image constituting the data set into any one of the plurality of classes by the AI classification tool 111 arranged in the setting window 101, and executes the image inspection by the normal inspection tools 131 and 132 corresponding to the classified class on the classified image.

In Step SC4, the result of the image processing by the flaw tool (screw) 132 is output, and the result of the image processing by the flaw tool (screw) 131 is output. At this time, the display control unit 13a can generate the user interface screen 100 for displaying, in the data set window 103, a result of the classification by the AI classification tool 111 and a result of the image inspection by the normal inspection tools 131 and 132. Therefore, the result can be presented to the user.

### Combination of Multiple AI Tools

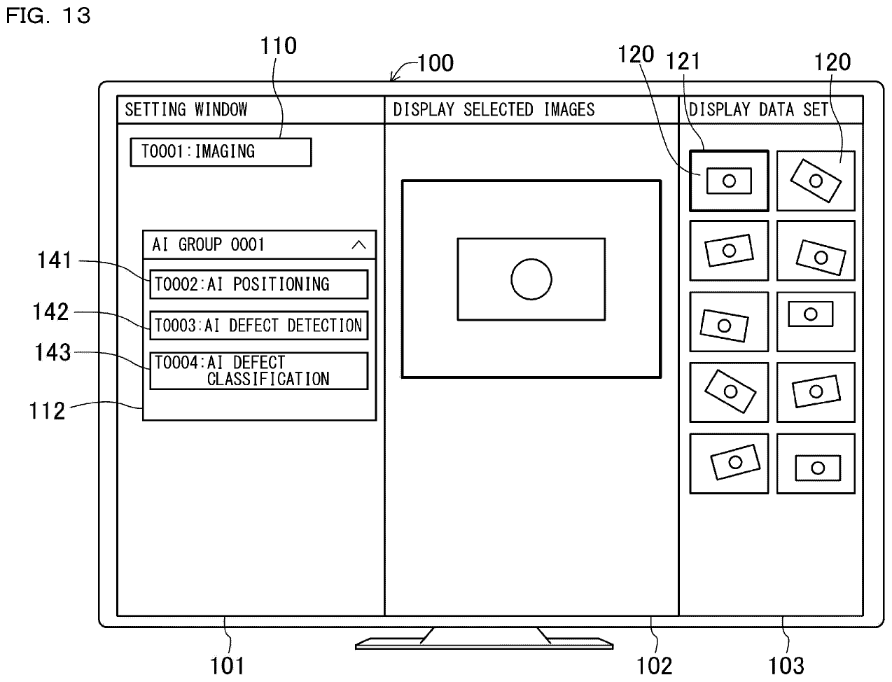

The image processing device 1 can use only the AI tool without using the rule-based tool. FIG. 13 illustrates the setting user interface screen 100 when a plurality of AI tools are combined. In the frame 112, an AI location tool 141, an AI defect detection tool 142, and an AI defect classification tool 143 are added as AI tools. The AI location tool 141 is arranged at the top and the AI defect classification tool 143 is arranged at the bottom. This arrangement order corresponds to the processing order.

That is, the AI location tool 141 executes the image processing of moving around the inspection target area by the machine learning model. The image moved around the inspection target area by the image processing of the AI location tool 141 is input to the AI defect detection tool 142. The AI defect detection tool 142 executes the image processing of detecting a defect portion in the input image by the machine learning model. The defect portion extracted by the image processing of the AI defect detection tool 142 is input to the AI defect classification tool 143. The AI defect classification tool 143 executes the image processing of classifying the type of the defect according to the machine learning model. The types of defects include, for example, flaw and dirt.

This example includes a plurality of types of AI tools. To train the machine learning model, labeled training data for the AI location tool 141, labeled training data for the AI defect detection tool 142, and labeled training data for the AI defect classification tool 143 are prepared.

### Details of Position Correction

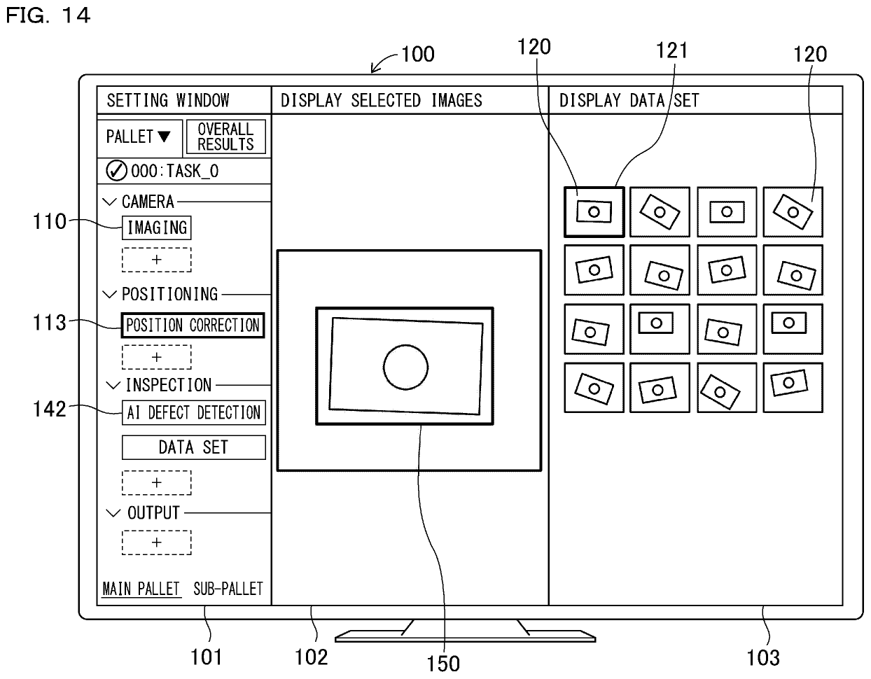

At the time of position correction, the user can designate the target area of the image processing by the AI classification tool 111. When the position correction tool 113 is selected as in the setting user interface screen 100 illustrated in FIG. 14, an image selected from the plurality of images displayed in the data set window 103 is displayed in the selected image display area 102. In the selected image display area 102, an area designation frame 150 for designating the target area of the image processing by the AI classification tool 111 is displayed in a manner superimposed on the image. The position, size, aspect ratio, and the like of the area designation frame 150 on the image can be changed by the user operating the mouse 52. If the entire workpiece in the image is set as the target area of the image processing, the user operates the mouse 52 to change the position, size, aspect ratio, and the like of the area designation frame 150 such that the area designation frame 150 surrounds the entire workpiece and is as small as possible. If only a part of the workpiece is set as the target area of the image processing, the user operates the mouse 52 to change the position, size, aspect ratio, and the like of the area designation frame 150 such that the area designation frame 150 surrounds only the part of the workpiece. When the user performs a determination operation after the change, the input unit 13b receives the area surrounded by the area designation frame 150 as the target area of the image processing. That is, the input unit 13b is configured to receive the designation of the target area of the image processing by the machine learning tool in the images included in the data set, and thus can exclude the unnecessary part from the determination target. In addition, if only the target area is used for training at the time of training the machine learning model as well, the part other than the target area can be excluded, which improves the training effect.

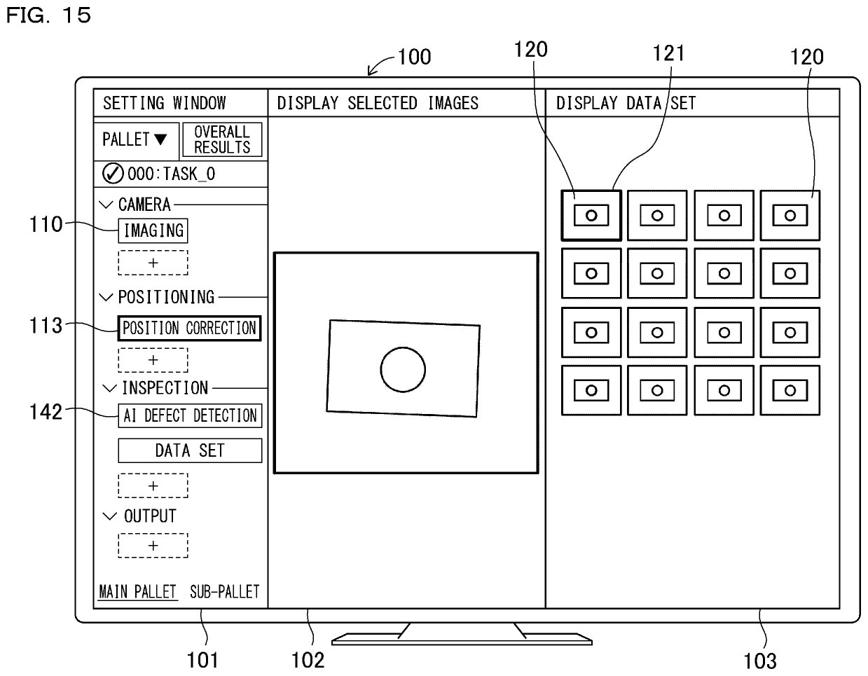

If the input unit 13b receives the designation of the target area of the image processing, the processor 13c executes the position correction such that the position of the workpiece detected in each image is included in the target area designated by the user. Specifically, the processor 13c generates a plurality of processed images by executing the position correction by the position correction tool 113 on each of the plurality of images constituting the data set. FIG. 15 illustrates the setting user interface screen 100 after the position correction by the position correction tool 113 is executed. The position correction is performed such that the target areas of all the plurality of images displayed in the data set window 103 are in the same direction. These images are processed images. As described above, the display control unit 13a generates the setting user interface screen 100 for displaying the plurality of processed images in the data set window 103. Thereby, the user can check whether the image processing by the rule-based tool is correctly executed on the images before being input to the machine learning model. According to the setting user interface screen 100, if workpieces are detected in the images by the position correction, the plurality of images of the data set can be displayed in the data set window 103 in a state where the detected workpieces are included in the target areas.

After the position correction is executed, the image processing by the machine learning tool is executed on the target area of each image of the data set displayed in the data set window 103.

### Details of AI Tool Selection

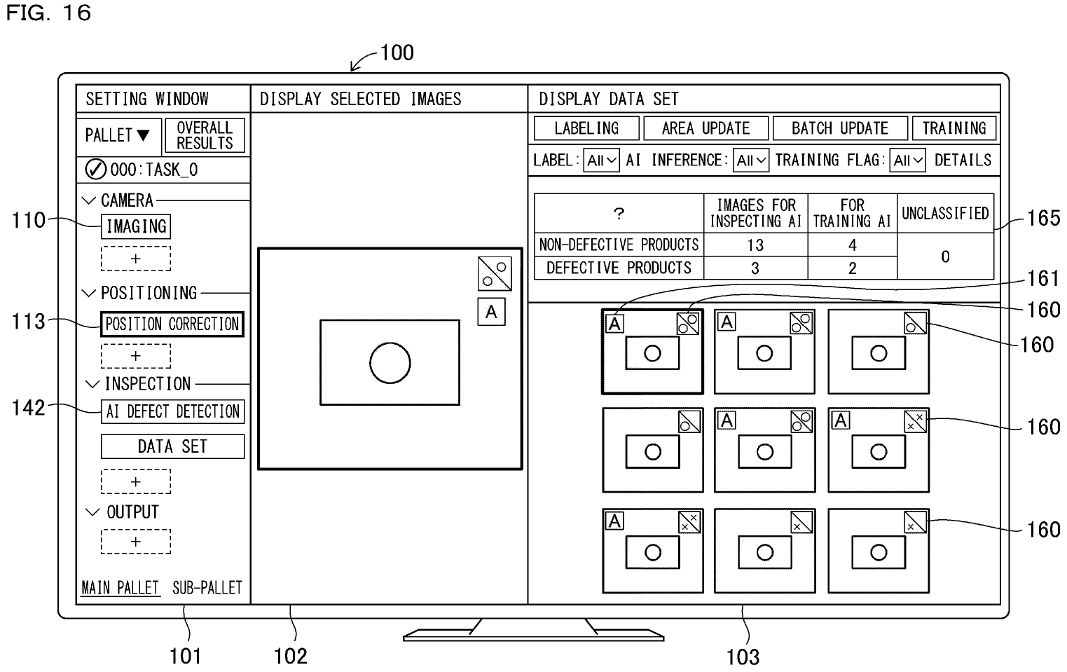

FIG. 16 illustrates the setting user interface screen 100 at the time of AI tool selection. Each image of the data set displayed in the data set window 103 is attached with a first icon 160. The first icon 160 indicates non-defective product image, defective product image, training image, and inspection image. A circular mark attached to the upper right of the first icon 160 indicates that the image is a non-defective product image and is a training image and an inspection image. A circular mark attached to the lower left of the first icon 160 indicates that the image is a non-defective product image and is an inspection image. A cross mark attached to the upper right of the first icon 160 indicates that the image is a defective product image and is a training image and an inspection image. A cross mark attached to the lower left of the first icon 160 indicates that the image is a defective product image and is an inspection image. Each image of the data set displayed in the data set window 103 is also attached with a second icon 161 indicating that the image is an image used for the training. The first icon 160 and the second icon 161 may be in any form as long as the above-described information can be displayed.

The processor 13c outputs an inference result of each of the plurality of processed images after the position correction is executed by executing image processing by the machine learning tool on the processed image. The display control unit 13a generates the setting user interface screen 100 for displaying the plurality of processed images and the inference results corresponding to the processed images in the data set window 103. That is, the data set window 103 is provided with an inference result display area 165. The inference result display area 165 displays the number of products inferred as non-defective products and the number of products determined as defective products in a table format, as the inference result obtained by inputting the inspection images among the images of the data set to the machine learning model and performing image processing. The inference result display area 165 displays the non-defective product images and the defective product images in a distinguishable form for the number of training images for training the machine learning model. The inference result display area 165 also displays the number of unclassified images. By displaying the setting user interface screen 100 illustrated in FIG. 16, the user can check the inference result based on the images after the rule-based processing that are actually taken as the basis for the machine learning model.

### Feature Area Emphasis

The image processing by the rule-based tool may be pre-processing of emphasizing the feature areas in the input images. Examples of the pre-processing of this type include contrast adjustment, and the feature areas can be emphasized by contrast adjustment.

In this case, the processor 13c generates a plurality of pre-processed images emphasizing the feature area of each of the plurality of images constituting the data set by executing the pre-processing of emphasizing the feature area on the image. As in the case of the position correction, the display control unit 13a generates the setting user interface screen 100 for displaying the plurality of pre-processed images emphasizing the feature area in the data set window 103.

After executing the pre-processing of emphasizing the feature area, the processor 13c executes the image processing by the machine learning tool or the training of the machine learning model on the plurality of pre-processed images. That is, by executing the pre-processing of emphasizing the feature area, it is possible to emphasize the part to be determined by the machine learning model, thereby lowering the determination difficulty level in the image processing by the machine learning tool executed thereafter.

### Use Example of Multiple Imaging Units

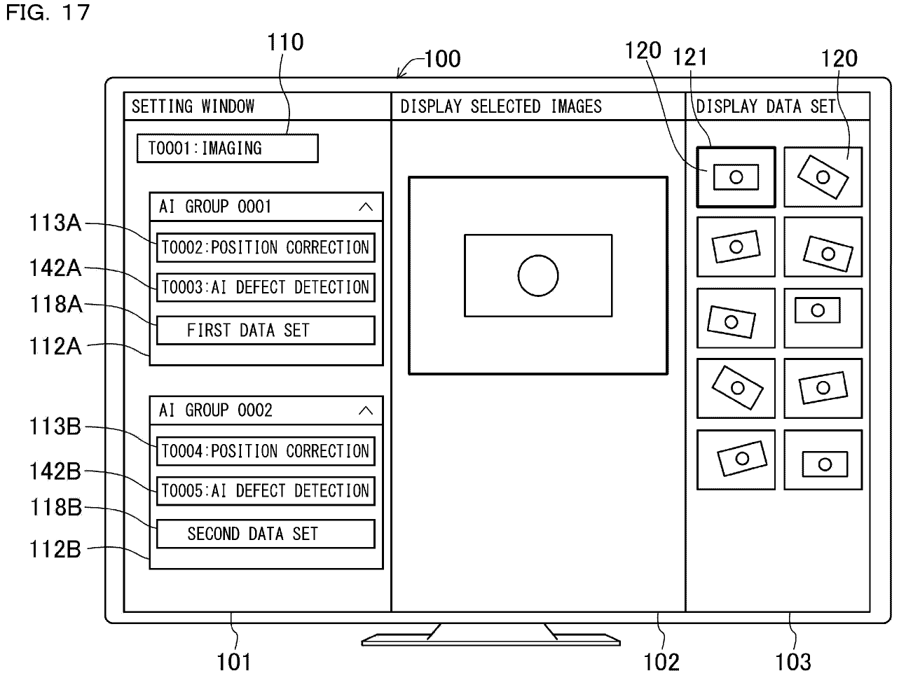

In each of the examples described above, a case where one imaging unit 3 is provided has been described, but the present embodiment is not limited thereto, and can be applied to a case where a plurality of imaging units 3 are provided. FIG. 17 is a diagram illustrating the setting user interface screen 100 in a case where the plurality of imaging units 3 are provided. The plurality of imaging units 3 are set with imaging visual fields for imaging different parts of the same workpiece. Accordingly, in this example, it is possible to simultaneously inspect a plurality of parts for one workpiece.

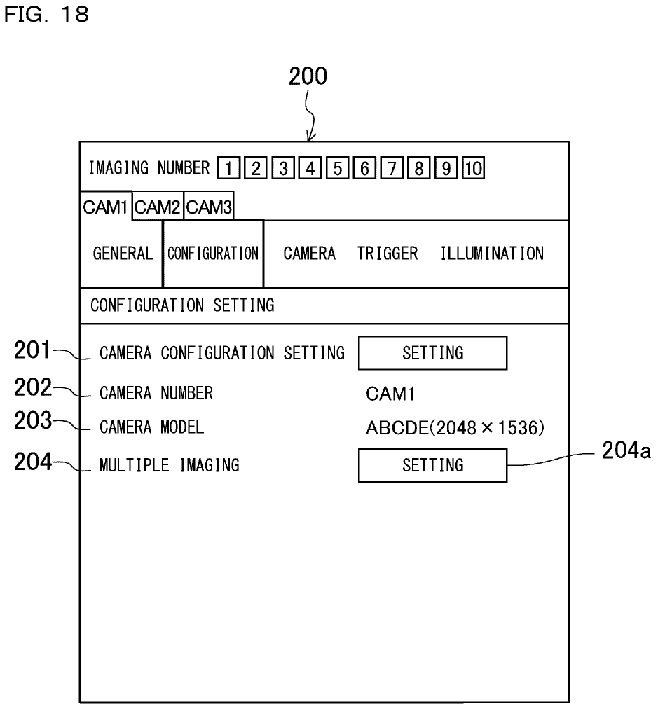

When the user selects the imaging tool 110 on the setting user interface screen 100 using the mouse 52 or the like, the display control unit 13a generates an imaging setting window 200 as illustrated in FIG. 18 and causes the display device 4 to display the imaging setting window 200. The imaging setting window 200 is provided with a camera configuration setting area 201, a camera number display area 202 for displaying a number unique to the imaging unit 3, a camera model display area 203 for displaying the model of the imaging unit 3, a multiple imaging setting area 204, and the like.

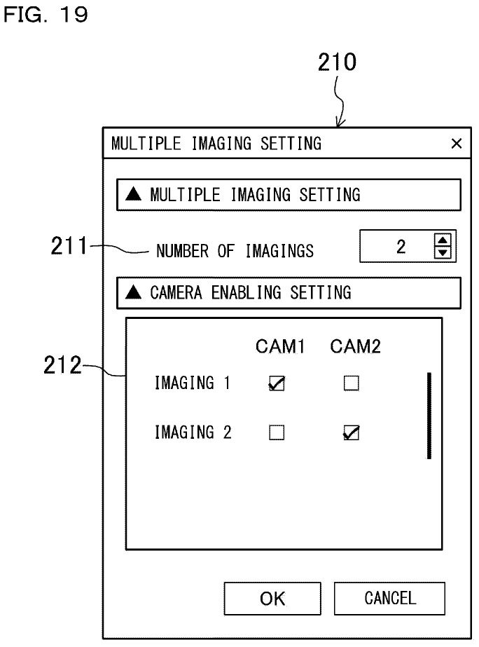

When the user operates a setting button 204a provided in the multiple imaging setting area 204 using the mouse 52 or the like, the display control unit 13a generates a multiple imaging setting window 210 as illustrated in FIG. 19 and causes the display device 4 to display the multiple imaging setting window 210. The multiple imaging setting window 210 is provided with a number-of-imagings setting area 211 for setting the number of imagings and a camera enabling setting area 212. In the camera enabling setting area 212, if the number of times set in the imaging number setting area 211 is, for example, two, it is set the imaging unit 3 for executing each of the first imaging and the second imaging. In this example, two imaging units 3 including “CAM1” and “CAM2” are used. The first imaging is executed by “CAM1” and the second imaging is executed by “CAM2”. This is an example, and the number of imagings may be set to three or more, or three or more imaging units 3 may be used.

Further, as illustrated in FIG. 17, two groups, that is, “AI group 0001” and “AI group 0002” are set based on the operation of the user. Specifically, the first group is set by arranging a first position correction tool 113A and a first AI defect detection tool 142A in a first frame 112A. A first data set tool 118A is arranged in the first frame 112A to allow the first position correction tool 113A and the first AI defect detection tool 142A to refer to the first data set tool 118A indicating the first data set including a plurality of images. The first position correction tool 113A is a first rule-based tool indicating image processing according to a predetermined rule, and the first AI defect detection tool 142A is a first machine learning tool indicating image processing using a machine learning model.

The second group is set by arranging a second position correction tool 113B and the second AI defect detection tool 142B in a second frame 112B. A second data set tool 118B is arranged in the second frame 112B to allow the second position correction tool 113B and a second AI defect detection tool 142B to refer to the second data set tool 118B indicating the second data set including a plurality of images. The second position correction tool 113B is a second rule-based tool indicating image processing according to a predetermined rule, and the second AI defect detection tool 142B is a second machine learning tool indicating image processing using a machine learning model.

As described above, the input unit 13b receives a user input for: arranging in the setting window 101 the first AI defect detection tool 142A, the second AI defect detection tool 142B, the first position correction tool 113A and the second position correction tool 113B; causing the first AI defect detection tool 142A and the first position correction tool 113A arranged in the setting window 101 to refer to the first data set tool 118A; and causing the second AI defect detection tool 142B and the second position correction tool 113B arranged in the setting window 101 to refer to the second data set tool 118B different from the first data set tool 118A.

If two groups are set, the display control unit 13a generates the first frame 112A and the second frame 112B and displays them in the setting window 101. Therefore, the user can easily and accurately determine which tool belongs to which group and which group includes which tools. That is, the display control unit 13a generates the user interface screen 100 for displaying the first frame 112A in the setting window 101 as the first indicator indicating that the first AI defect detection tool 142A and the first position correction tool 113A arranged in the setting window 101 both refer to the first data set tool 118A. Further, the display control unit 13a generates the user interface screen 100 for displaying the second frame 112B in the setting window 101 as the second indicator indicating that the second AI defect detection tool 142B and the second position correction tool 113B arranged in the setting window 101 both refer to the second data set tool 118B.

At the time of setting the image processing device 1, if “CAM1” is set as the first imaging unit and “CAM2” is set as the second imaging unit, the first data set tool 118A is constituted by a plurality of images captured by the first imaging unit, and the second data set tool 118B is constituted by a plurality of images captured by the second imaging unit. The first AI defect detection tool 142A is trained by the plurality of images constituting the first data set tool 118A, and the second AI defect detection tool 142B is trained by the plurality of images constituting the second data set tool 118B.

In operation of the image processing device 1, the image processing by the first position correction tool 113A is executed on the input images captured by the first imaging unit, and the image processing by the first AI defect detection tool 142A is executed on the input images after the image processing by the first position correction tool 113A is executed to determine the presence or absence of a defect. Further, the image processing by the second position correction tool 113B is executed on the input image captured by the second imaging unit, and the image processing by the second AI defect detection tool 142B is executed on the input image after the image processing by the second position correction tool 113B is executed to determine the presence or absence of a defect. The result output from the first AI defect detection tool 142A and the result output from the second AI defect detection tool 142B are integrated to perform final quality determination.

### Indicators

The examples described above have described the case where the indicators indicating that the machine learning tool and the rule-based tool arranged in the setting window 101 both refer to the data set are the frame 112 (illustrated in FIG. 7), the first frame 112A, and the second frame 112B (illustrated in FIG. 17), but the indicators may be lines, arrows, or the like connecting the tools.

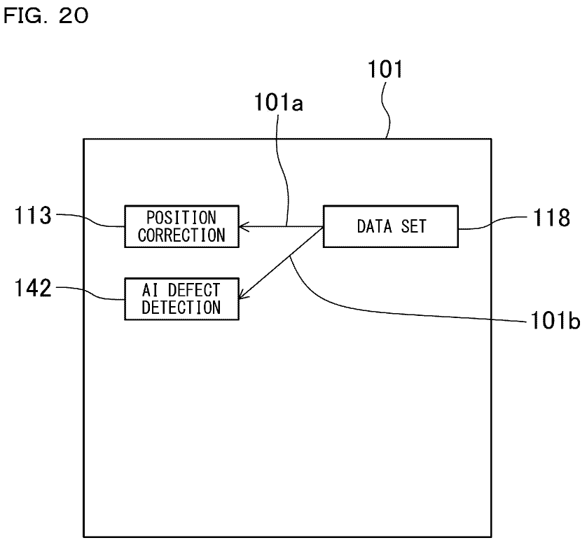

That is, as illustrated in FIG. 20, if the position correction tool 113 and the AI defect detection tool 142 are arranged in the setting window 101, a data set tool 118 referred to by the position correction tool 113 and the AI defect detection tool 142 may also be arranged in the setting window 101, and a line 101a connecting the data set tool 118 and the position correction tool 113 and a line 101b connecting the data set tool 118 and the AI defect detection tool 142 can be displayed. For example, when the user operates the mouse 52 to perform an operation of associating the data set tool 118 with the position correction tool 113, the operation is received by the input unit 13b, the display control unit 13a displays the line 101a in the setting window 101. When the user performs an operation of associating the data set tool 118 with the AI defect detection tool 142, the operation is received by the input unit 13b, and the display control unit 13a displays the line 101b in the setting window 101. The lines 101a and 101b are indicators indicating that the position correction tool 113 and the AI defect detection tool 142 refer to the common data set tool 118. Arrows or the like may be used as indicators instead of the lines 101a and 101b.

The above-described embodiment has described an example in which the frame 112 and the line 101a are displayed as indicators to indicate that the machine learning tool and the rule-based tool arranged in the setting window 101 refer to a common data set. However, a mode without displaying the indicator is not excluded. That is, if the setting window 101 includes a plurality of tools that refer to a common data set and other tools that do not refer to the data set, the plurality of tools may be arranged closer to each other than the other tools, thereby indicating that the plurality of tools refer to the common data set.

The method for causing the plurality of tools to refer to the common data set is not limited to the above-described example. For example, the first tool may refer to the data set, and the second tool may refer to the data set by selecting another second tool in the setting window in a state where the data set window indicating the data set is displayed on the user interface screen. In another method, if the data set is first input and then the tools are sequentially arranged in the setting window, the data set may be automatically referred to by the tools sequentially arranged in the setting window. In another method, if the tools are first arranged in the setting window and then the data set is input, all the tools arranged in the setting window may automatically refer to the data set.

The above-described embodiment is merely an example in all respects, and should not be construed in a limited manner. Further, modifications and changes belonging to an equivalent scope of the claims are all within the scope of the present invention.

### INDUSTRIAL APPLICABILITY

As described above, the image processing device according to the present disclosure can be used, for example, to perform appearance inspection of an industrial product.

What is claimed is:

1. An image processing device for executing image processing by a machine learning tool and image processing by a rule-based tool, the image processing device comprising:
a UI generation unit configured to generate a user interface screen for displaying a setting window for setting the image processing and to cause a display unit to display the user interface screen;
an input unit configured to receive
an input for arranging, in the setting window of the user interface screen, a machine learning tool indicating image processing by a machine learning model and a rule-based tool indicating image processing according to a predetermined rule, and
an input of a common data set including a plurality of images to be referred to by the machine learning tool and the rule-based tool; and
an image processing unit configured to execute one of the image processing by the machine learning tool or the image processing by the rule-based tool on the data set, and execute the other image processing on the data set after the one image processing is executed.

2. The image processing device according to claim 1, wherein
the UI generation unit generates a user interface screen for displaying, side by side with the setting window, a data set window for displaying the images included in the data set referred to by both the machine learning tool and the rule-based tool arranged in the setting window.

3. The image processing device according to claim 2, wherein
the image processing unit generates a plurality of processed images by executing the image processing by the rule-based tool on the plurality of images constituting the data set, and
the UI generation unit generates a user interface screen for displaying the plurality of processed images in the data set window.

4. The image processing device according to claim 2, wherein
the image processing unit outputs an inference result of each of the plurality of processed images by executing the image processing by the machine learning tool on the processed image, and
the UI generation unit generates a user interface screen for displaying the plurality of processed images and the inference result corresponding to each of the processed images in the data set window.

5. The image processing device according to claim 2, wherein
the image processing unit:
trains the machine learning model with the plurality of images displayed in the data set window and a result of executing the image processing by the rule-based tool on the plurality of images;
executes the image processing by the rule-based tool on an inspection target image in which a workpiece is imaged; and
executes the image processing using the trained machine learning model on the inspection target image based on an execution result of the image processing by the rule-based tool.

6. The image processing device according to claim 2, wherein
the image processing unit:
extracts a feature from each of the plurality of images included in the data set;
detects a position of a workpiece included in the image based on the extracted feature;
executes position correction based on the detected position of the workpiece, such that the workpiece in each of the plurality of images to be subjected to the image processing by the machine learning tool have the same position and posture; and
executes the image processing by the machine learning tool on the plurality of images subjected to the position correction.

7. The image processing device according to claim 6, wherein
the input unit is configured to receive designation of target areas of the image processing by the machine learning tool in the images included in the data set, and
the image processing unit:
executes the position correction such that the position of the workpiece detected in each image is included in the designated target area; and
executes the image processing by the machine learning tool on the target area of each image of the data set.

8. The image processing device according to claim 7, wherein
the UI generation unit generates a user interface screen for displaying the plurality of images of the data set in the data set window, in a state where the workpiece detected in each image is included in the target area due to the position correction.

9. The image processing device according to claim 1, wherein
the image processing according to the predetermined rule by the rule-based tool is pre-processing of emphasizing a feature area in an input image, and
the image processing unit:
generates a plurality of pre-processed images emphasizing a feature area of each of the plurality of images constituting the data set by executing the pre-processing on the image; and
executes the image processing by the machine learning tool or training of the machine learning model on the plurality of pre-processed images.

10. The image processing device according to claim 1, wherein
the UI generation unit generates a user interface screen for displaying, in the setting window, an indicator indicating that the machine learning tool and the rule-based tool arranged in the setting window both refer to the data set.

11. The image processing device according to claim 1, wherein
the input unit receives user input for:
arranging in the setting window a first machine learning tool and a second machine learning tool indicating image processing using a machine learning model, and a first rule-based tool and a second rule-based tool indicating image processing according to a predetermined rule;
causing the first machine learning tool and the first rule-based tool arranged in the setting window to refer to a first data set including a plurality of images; and
causing the second machine learning tool and the second rule-based tool arranged in the setting window to refer to a second data set including a plurality of images, and
the UI generation unit generates a user interface screen for displaying, in the setting window:
a first indicator indicating that the first machine learning tool and the first rule-based tool arranged in the setting window both refer to the first data set; and
a second indicator indicating that the second machine learning tool and the second rule-based tool arranged in the setting window both refer to the second data set.

12. The image processing device according to claim 2, wherein
the image processing unit:
executes the image processing by the machine learning tool on the plurality of images constituting the data set; and
executes the image processing by the rule-based tool on the plurality of images on which the image processing by the machine learning tool is executed.

13. The image processing device according to claim 12, wherein
the machine learning tool includes a classification tool indicating classification of classifying an input image into any one of a plurality of classes by the machine learning model,
the rule-based tool includes a normal inspection tool indicating image inspection based on a predetermined rule,
the input unit receives a user input for:
arranging in the setting window the classification tool and the normal inspection tool corresponding to each of the plurality of classes; and
causing the classification tool and the plurality of normal inspection tools arranged in the setting window to refer to the data set including the plurality of images,
the image processing unit:
classifies each image constituting the data set into any one of the plurality of classes by the classification tool arranged in the setting window; and
executes image inspection on the classified image by the normal inspection tool corresponding to the classified class, and
the UI generation unit generates a user interface screen for displaying, in the data set window, a result of the classification by the classification tool and a result of the image inspection by the normal inspection tools.

14. The image processing device according to claim 1, wherein
the input unit receives a user input for causing the machine learning tool and the rule-based tool to refer to the data set.

15. An image processing method for executing image processing by a machine learning tool and image processing by a rule-based tool, the image processing method comprising:
a step for generating a user interface screen for displaying a setting window for setting the image processing and to cause a display unit to display the user interface screen;
a step of receiving
an input for arranging, in the setting window of the user interface screen, a machine learning tool indicating image processing by a machine learning model and a rule-based tool indicating image processing according to a predetermined rule, and
an input of a common data set including a plurality of images to be referred to by the machine learning tool and the rule-based tool; and
a step of executing one of the image processing by the machine learning tool or the image processing by the rule-based tool on the data set, and executing the other image processing on the data set after the one image processing is executed.
